(19) United States
(12) Patent Application Publication
(10) Pub. No.: US 2004/0229478 A1
(43) Pub. Date: Nov. 18, 2004

(54) Rotatory wireless USB network interface card

(76) Inventor: Chao Ming Chen, Hsin-Shi (TW)

Correspondence Address: PRO-TECHTOR INTERNATIONAL SERVICES, 20775 Norada Court, Saratoga, CA, 95070-3018, US

(21) Appl. No.: 10/603,393

(22) Filed: Jun. 24, 2003

(30) Foreign Application Priority Data
May 13, 2003 (TW) 092.208.728

(51) Int. Cl. H01R 39/00

(52) U.S. Cl. 439/11

(57) ABSTRACT

A rotatory wireless USB network interface card setup is disclosed including a wireless network interface card, an USB connector, a USB connector fastener, a rotating and swing mechanism characterized in that the said wireless network interface card can rotate within the range of 270°, and swing up and down within the range of 180°, with the said rotating and swing mechanism between the said USB connector and the said wireless network interface card being pivot, whereof the said rotating and swing mechanism's shape likes T, with two axles intersecting each other perpendicularly and splitting into upper and lower halves which are fastened together by connector fastener and setup cover separately. The present invention can adjust the space occupied by wireless network interface card, and avoid problem of lacking space resulting from using several USB connectors simultaneously. Furthermore, the rotating and swing function can adjust orientation of wireless network interface card to increase receiving efficiency of wireless signal.

### BACKGROUND OF THE INVENTION

1. Field of the Invention

The present invention relates to a wireless USB network interface card, particularly to a rotatory wireless USB network interface card whereby the space around USB sockets and connectors can be adjusted according to user's need. Furthermore, another object of the present invention is to increase efficiency of wireless signal receiving by the rotatory function of the preset invention.

2. Description of Related Art

Due to rapid development of information technology, a computer often operates with several peripheries, and possesses a plurality of USB sockets which occupy limited space. When the conventional wireless USB network interface card connect with one of the USB sockets, another USB socket usually can not be used because of space being occupied by wireless network interface card, and it results in inconvenience or spending money in expansion of USB socket.

There is another conventional wireless USB network interface card possessing swing function whereby it can swing up and down 180° only, but when being used in the occasion of note book computer, that conventional art with swing function also results in inconvenience.

The note book computer is often placed on the table, and its USB sockets are set side by side together ordinarily. The USB sockets can accommodate another USB connector with the conventional wireless USB network interface card swinging up, but when the USB socket connects with mobile USB interface hard disc or accessory compact flash disc, owing to incapacity of swinging down of the disc, in contrast to swinging up of the conventional wireless USB network interface card, application of conventional wireless USB network interface card conflicts with application of mobile hard disc or accessory compact flash disc.

### SUMMARY OF THE INVENTION

An object of the present invention is to provide a wireless USB network interface card setup with rotating and swing mechanism whereby rotatory wireless USB network interface card of the present invention can rotate in a range of 270° and swing up and down in a range of 180°, with the rotating and swing mechanism between USB connector and wireless USB network interface card itself being pivot, and to provide adjusting capacity of space around USB sockets and connectors and convenience of using USB sockets. Furthermore, another object of the present invention is to provide more freedom of orientation adjusting for more efficiency receiving of wireless signal.

### BRIEF DESCRIPTION OF THE DRAWINGS

FIG. 1 illustrates the perspective view of the whole setup of the present invention

FIG. 2 illustrates the top side view and left side view of the present invention setup with its rotating and swing range indicated by arrows

FIG. 3 illustrates the perspective view of interior of the present invention

FIG. 4 illustrates the perspective exploded view of the present invention FIG. 5 illustrates the motion perspective view of rotating and swing of the rotatory wireless USB network interface card engaged with a note book computer.

### LIST OF REFERENCE NUMERALS

10 USB connector fastener

101 fastener's upper half

102 fastener's lower half

20 USB connector

30 rotating and swing mechanism

301 mechanism's upper half

302 mechanism's lower half

40 wireless USB network interface card

50 setup cover

501 upper half cover

502 lower half cover

60 indicator

70 setup top cover

### PREFERRED EMBODIMENTS

By referring to the following description and accompanying drawings, preferred embodiments will be demonstrated clearly.

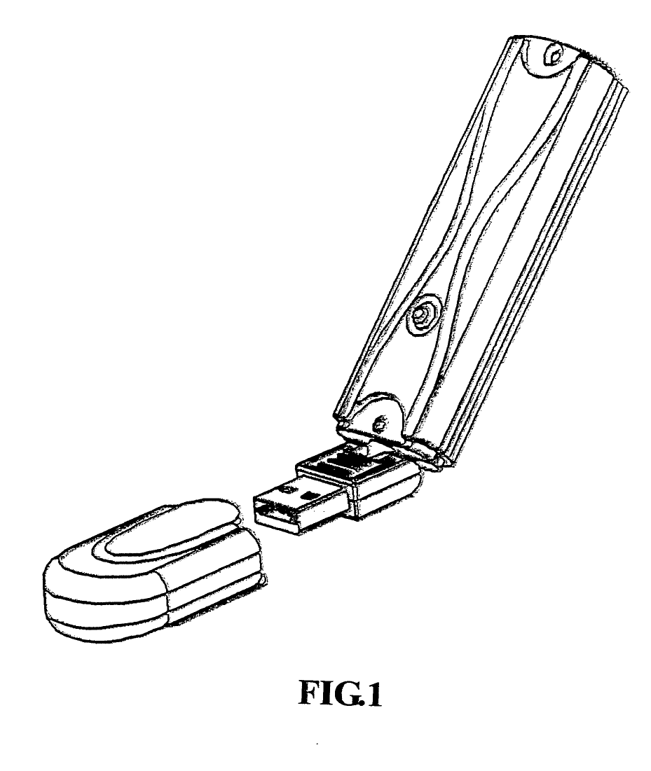

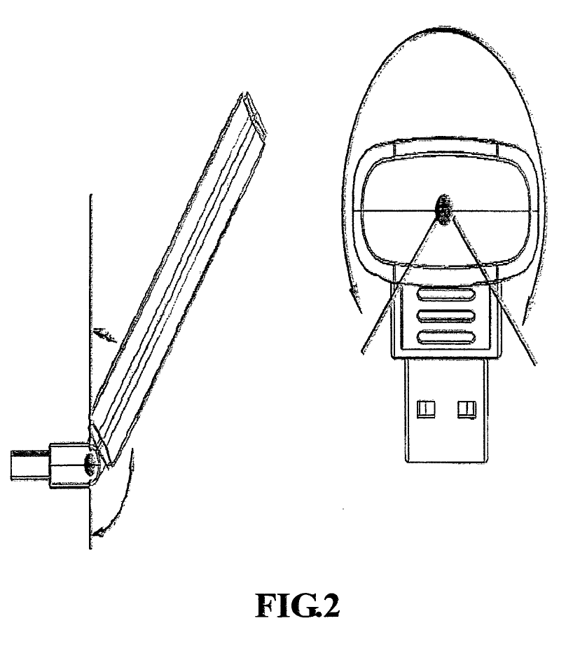

FIG. 1 illustrates the perspective view of whole setup of the present invention.

FIG. 2 illustrates the top side view and left side view of the setup of the present invention, wherein two black points are pivots of swing and rotating motion separately with rotating range of 270° and swing range of 180° indicated by arrows.

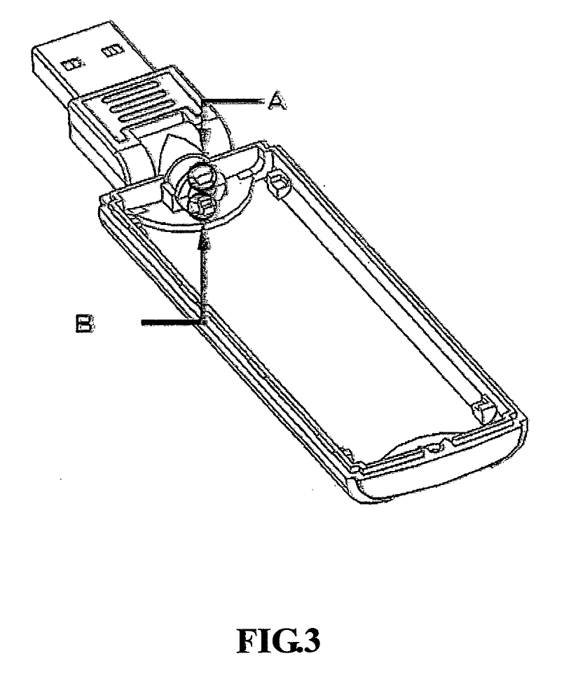

FIG. 3 illustrates the perspective view of interior of the present invention, wherein, when wireless network interface card rotating, point A will be limited by point B to avoid over-rotating and damaging of the wires communicating USB connector and wireless network interface card.

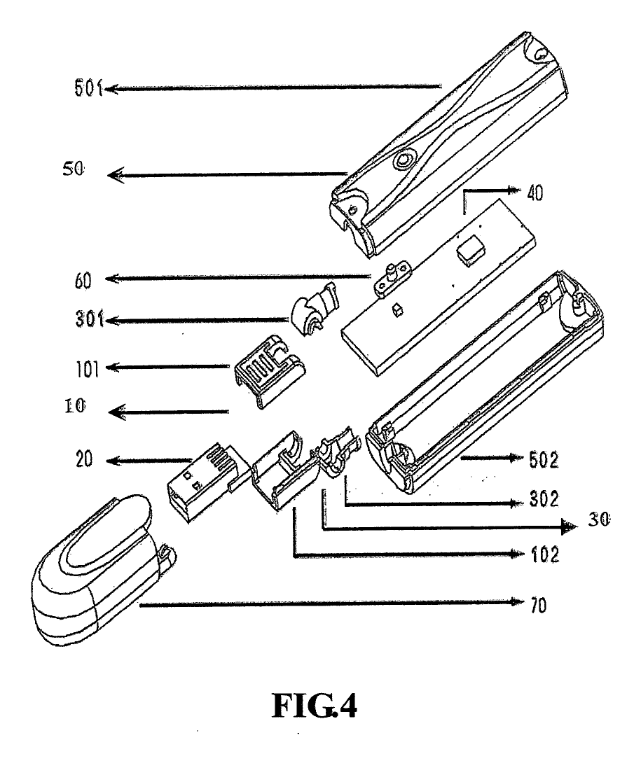

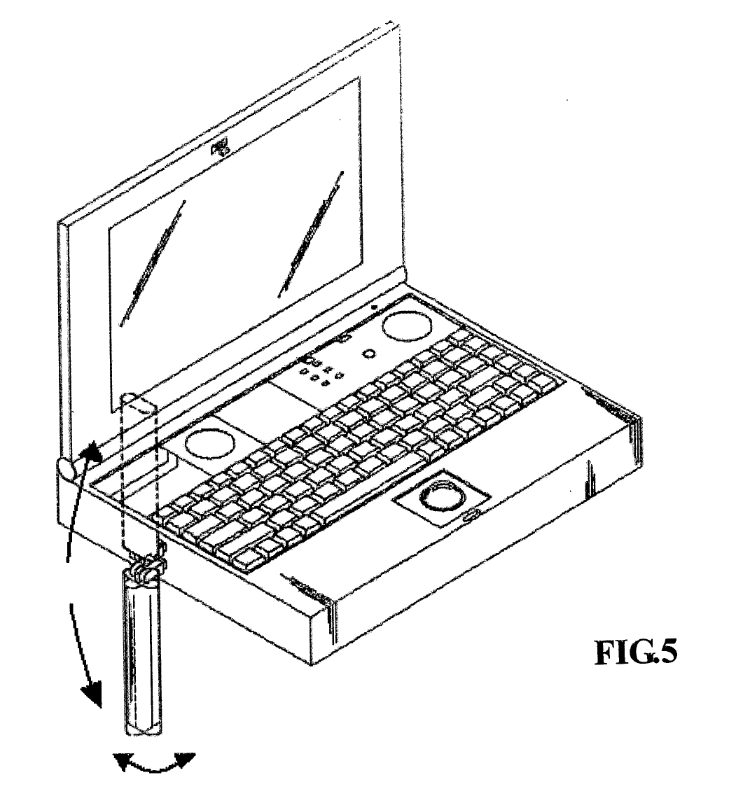

FIG. 4 illustrates the perspective exploded view of the present invention, wherein there is USB connector fastener 10 splitting into fastener's upper half 101 and fastener's lower half 102. One side of connector fastener 10 clamps USB connector 20 and the other side clamps rotating and swing mechanism 30 which splits into mechanism's upper half 301 and mechanism's lower half 302. The rotating and swing mechanism 30's shape like T wherein the horizontal swing axle intersects the vertical rotating axle perpendicularly. The both halves of rotating axle is clamped by setup cover 50, which splits into upper half cover 501 and lower half cover 502.

There is circuit board 40 of wireless network interface card contained inside the setup cover 50, wherein there is indicator 60 which lights when wireless signal is transmitted.

There is top cover 70 which engages with setup cover 50.

FIG. 5 illustrates motion perspective view of rotating and swing of the present invention engaged with a note book computer.

While the present invention has been described with reference to the preferred embodiments thereof, it is to be understood that modifications and variations may be easily made without departing from the spirit of this invention which is defined by the appended claims.

What is claimed is:

1. A rotatory wireless USB network interface card setup including a wireless network interface card, an USB connector, a USB connector fastener, a rotating and swing mechanism, characterized in that the said wireless network interface card can rotate within the range of 270°, and swing up and down within the range of 180°, with the said rotating and swing mechanism between the said USB connector and the said wireless network interface card being pivot, whereof the said rotating and swing mechanism's shape likes T, with two axles intersecting each other perpendicularly and splitting into upper and lower halves which are fastened together by connector fastener and setup cover separately.

2. Invention according to claim 1 further including groove in the said rotating and swing mechanism for being engaged with the said setup cover.

3. Invention according to claim 1 further including groove in the said rotating and swing mechanism for being engaged with the said USB connector fastener.

4. Invention according to claim 1 further including slip-proof washer ring between the said rotating and swing mechanism and the said setup cover.

5. Invention according to claim 1 further including slip-proof washer ring between the said rotating and swing mechanism and the said USB connector fastener.
